(19) United States
(12) Patent Application Publication
(10) Pub. No.: US 2007/0198669 A1
(43) Pub. Date: Aug. 23, 2007

(54) PLUG-AND-PLAY DEVICE FOR VIDEOPHONY APPLICATIONS ON PACKET-SWITCHED NETWORKS

(75) Inventors: Gabriella Convertino, Francavilla Fontana (IT); Fabrizio Crudo, Lecce (IT); Antonio Vilei, Lecce (IT)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS S.R.I., Agrate Brianza (IT)

(21) Appl. No.: 11/671,773

(22) Filed: Feb. 6, 2007

(30) Foreign Application Priority Data
Feb. 7, 2006 (IT) TO2006A000083

(51) Int. Cl. G06F 15/177

(52) U.S. Cl. 709/220

(57) ABSTRACT

A device of a plug-and-play type, which can be integrated in a home network having at least one audio-video Media-Server device or else at least one audio-video Media-Renderer device. The device can be activated for selectively configuring parameters and devices for setting up audio-video calls for connection between the home network and a packet network, such as the Internet. Preferentially, the device is based upon UPnP (Universal Plug-and-Play) technology and uses either a signaling protocol on IP packet network, such as the Session Initiation Protocol (SIP) and ITU-T H.323, or else mobile communications systems, such as the Universal Mobile Telecommunications System (UMTS). The device is able to redirect audio-video streams in the context of a plurality of devices capable of reproducing them and/or to selectively acquire said audio-video streams from a plurality of devices capable of supplying them.

### BACKGROUND OF THE INVENTION

1. Field of the Invention

The present invention relates to techniques for the transmission of voice and video in real time on packet-switched networks, especially on the Internet.

2. Description of the Related Art

The techniques generically referred to as “Voice and Video over IP” (VVoIP), designed to enable voice and video transmission in real time on packet-switched networks with the use of the Internet Protocol (IP) are the subject of an ever-increasing interest, linked mainly to the significant reduction in the costs that can be achieved in long-distance digital communications.

The advantages of telephony on the Internet can be more easily understood if compared with the characteristics of normal telephone networks, known as “Public Switched Telephone Networks” (PSTN). A PSTN is a circuit-switched network optimized for voice communications synchronously and in real time with a guaranteed quality of service (QoS). Activation of a communication session hence involves setting-up of a physical circuit between the caller and the called party. The PSTN guarantees the quality of service, dedicating to conversation a full-duplex circuit with a bandwidth of 64 kHz. The bandwidth remains unaltered irrespective of whether the parties are in active conversation or silent. It follows that the cost of a call via PSTN is mainly linked, not only to the distance, but also to the time of occupation of the network.

The Internet, instead, is a packet-switched network and, historically, has always been used for all those applications (e-mail, ftp, etc.) where the QoS did not constitute a fundamental prerogative. Packet-switched networks do not define and dedicate a circuit between the parties involved in the conversation, but transfer the packets that carry the information, eliminating from the transmission the parts that are not useful, such as moments of silence in the case of voice.

The main parameter for evaluating the cost is hence neither the distance nor the time, but the bandwidth used in the communication. In any case, said cost is transparent to the end user. The service is in fact provided usually by the Internet Service Providers (ISP), who manage the cost of the connections directly.

As regards the end user, IP telephony hence constitutes a medium for communicating at intercontinental distances at the prices of a telephone call within the local PSTN. Above all for this reason, for the VVoIP market there is forecast an exponential growth for the next few years in all the principal sectors (i.e., PC-to-PC telephony, PC-to-phone telephony, phone-to-PC telephony, and the classic phone-to-phone telephony).

A disadvantage so far noted in communications on IP lies in the quality of the transmission, in so far as a packet-switched network cannot guarantee the quality of service. Today, however, there exist techniques of compression and recovery of the packets that enable correction and minimization of these drawbacks, enabling conversations that are almost always clear and fluid.

With the integration of voice and data infrastructures, in addition to the transmission of the normal telephone signal, VVoIP techniques enable implementation of different alternative communications systems:
voice-mail and unified-messaging systems for joint management of telephony and of message systems, such as e-mail, fax, and automatic intercept;
advanced systems such as video-conferencing, application sharing (desktop-shared applications), and white-boarding (applications that enable users to see and interact with a sort of shared “whiteboard”).

Various protocols have been developed over time for the VVoIP service: H323 and SIP (Session Initiation Protocol) are examples of application-level protocols that define the setting-up, modification, and ending of the multimedia sessions between users.

The initialization protocol of a SIP session has been developed starting from 1999 (Request For Comment 2543 and 3261) on the initiative of IETF and forms part of the Internet Multimedia Conferencing Suite. This is a text-based Web-oriented protocol, similar to the HTTP protocol, with a client-server structure, designed for being:
integrated with existing IETF protocols;
scalable and simple;
mobile;
readily implementable in the creation of services and characteristics;
independent of the transport protocol; and
readily extendible and programmable.

In this connection, there have recently emerged new technologies for home networks that introduce protocols capable of simplifying enormously the integration and inter-operability of technologically different devices.

The Universal Plug-and-Play (UPnP) technology is widely accepted and supported, and is moreover the basic component of the guidelines of Digital Living Networking Alliance, an alliance that is the effective standard for inter-operability of the devices.

UPnP technology offers to the user the opportunity of enjoying all the multimedia contents present in a home, without being concerned with the details of the source and where it is physically located. For example, according to the specifications regarding the audio/video architecture of UPnP technology, the devices that provide contents (such as, for example, an STB, a PC, or a videocamera) and the devices that reproduce contents (such as, for example, a TV set, a PC, or a PDA palmtop), can be automatically “identified” and automatically connected together, using a control point of the communication media (Media Control Point).

In particular, UPnP technology defines an architecture for the pervasive connectivity to networks of smart apparatuses, wireless devices, and PCs of any kind, of a peer-to-peer type (i.e., networks in which each component has the same level of importance as the others). UPnP technology was created to facilitate use, rendering more flexible and create standard bases for ad-hoc networks and for networks that do not have an administrator, such as home networks, office networks, networks for public areas, or networks connected to the Internet.

UPnP technology is an open architecture that is based upon the basic technologies of the Web, such as TCP/IP (Transmission Control Protocol/Internet Protocol) and other technologies for managing data transfer between network apparatuses or devices within home networks.

UPnP technology is designed for supporting zero-configuration networks, invisible networking, and automatic recognition of a vast range of devices. This means that a device can come to form part of the network, obtain an IP address, and detect in a dynamic way the presence and the characteristics of the other devices present. Furthermore, each device can at any moment be disconnected, without thereby raising problems of configuration for the entire network architecture. Servers of a DHCP type and DNS type can be supported.

The universality of UPnP technology is represented by the lack of specific drivers for the devices and by the use of widespread protocols. UPnP devices can be implemented in any programming language and can run on any operating system. Furthermore, UPnP does not supply developers with starting APIs (Application Program Interfaces) on which to build the software, but simply provides guidelines and rules of construction that the developers are bound to observe. Each device designed and constructed will obtain the certification of UPnP compatibility only after passing severe tests.

One of the main objectives of UPnP applications is to offer the inter-operability between devices produced by different manufacturers. Typically, the inter-operability comprises the capacity of the devices to “discover” one another automatically and communicate with other devices connected to the network, exchanging information therewith.

UPnP technology is based upon an open and distributed network architecture that exploits technologies of the Internet and the Web, such as, for example, Hyper-Text Transport Protocol (HTTP), Simple Object Access Protocol (SOAP) and extended Mark-up Language (XML), for managing flexible data communications between any two devices, without the presence of any control point in the network.

The participants at the Universal Plug-and-Play Forum are responsible for establishing a standard protocol for the control of DCP (Device Control Protocol) devices. This protocol defines the syntax and the semantics for the devices and for the services that implement a specific class of functions. The term “device” is used in the specification of the UPnP architecture for defining a logic container of devices and services, where the services are logic entities that provide a set of actions to network devices of a Universal Plug-and-Play type. The actions of a service are activated by a control point, which is in turn defined as logic entity that can control specific services.

A physical UPnP device can combine multiple services and/or multiple control points.

The typical operations of UPnP devices are organized in the following steps:

1. Addressing: in the addressing points, the devices obtain an IP address through auto-IP or Dynamic Host Configuration Protocol (DHCP) mechanisms.

2. Discovery: in the search-and-discover step, the control points seek the devices and the services that are available, whilst the devices make their services known.

3. Description: once a control point finds a device or service of interest, it asks the device for a description document. Devices and services answer by transmitting description documents in XML format that define the actions and the attributes that they support.

4. Control: in this step, the control points invoke the actions described in the XML description documents associated to the services that they control. These actions are executed by the services and typically cause changes in the state of the services and of the attributes. The syntax and semantics of these actions of control is defined in the DCP associated with the class of device.

5. Eventing: the control points can receive a notification of the occurrence of a particular event associated to a specific service after having executed an operation of subscription to the specific event. Like the actions of control, events are defined in the corresponding DCP.

6. Presentation: the devices can choose to export an HTML interface for management of the device.

Universal Plug-and-Play (UPnP) technology defines a horizontal abstraction for the networks distributed with personal-computer devices and home-electronics devices, irrespective of any particular operating system, programming language, or physical medium used.

The UPnP audio-video specifications define the model of interaction between UPnP audio-video devices and the associated control points.

Plug-and-play audio-video devices include TV, VCR, CD/DVD players, set-top box, stereo-and-multichannel reproduction systems, cameras, videocameras for the Internet, and PCS.

Plug-and-play audio-video architecture enables the devices to support different types of contents of entertainment, such as, for example, MPEG2 and MPEG4 for video, JPEG for photos, and MP3 for audio. Said architecture moreover enables the use of different types of transfer protocols such as, for example, HTTP and RTP (Real-time Transport Protocol).

The solutions outlined above, when considered in general terms, suffer from different limitations.

There exist, in the first place, limitations of a strict physical nature. For example, it can happen that the user must be very close to a certain device to be able to make a call to another user (for example, because it is necessary to use a wire-connected microphone).

Furthermore, to offer new services, it may be necessary to have available additional hardware/software for managing the incoming and outgoing audio/video calls. In this connection, it may be noted that, traditionally, set-top-box (STB) devices are receivers for radiodiffused video communications and are equipped with audio/video decoders (typically MPEG2 decoders). In order to support the videophony services there should be added complete “codecs” (coders and decoders) and new software modules for supporting additional coding standards (videophony is typically based upon H.263, G.711, G.723, G.729). This means that the basic device must become more complex to be able to manage the new applications.

### BRIEF SUMMARY OF THE INVENTION

One embodiment of the present invention overcomes the drawbacks outlined previously, and in particular, provides improvements that enable enhancement of the performance of a Universal Plug-and-Play application based upon a multi-device model that will enable availability of video/voice applications on IP network (VVoIP).

According to one embodiment of the present invention, the drawbacks described above are overcome by a device as described in the disclosure. The present invention also relates to a corresponding computer program product that can be loaded into the memory of at least one computer and comprises portions of software code for the aforesaid computer to provide the function of the device according to the invention. As used herein, the reference to such a “computer program product” is to be understood as being equivalent to the reference to a computer-readable medium that contains instructions for controlling a computer system in order to co-ordinate execution of the method according to the invention. Reference to “at least one computer” is aimed at highlighting the possibility for the present invention to be implemented in a distributed and/or modular way.

The claims form an integral part of the description of the invention provided herein.

The solution described herein, corresponding to a currently preferred embodiment of the invention is based upon the Session Initiation Protocol (SIP) and is able to integrate any Media-Server UPnP AV device and any Media-Renderer UPnP AV device, introducing a new device, such as a UPnP VVoIP control point that will enable the user to configure all the parameters and devices necessary for setting up a video call.

The solution described herein, by way of example, is based upon UPnP technology and upon the SIP, but the same solution can be readily extended to other technologies. For example, the SIP can be replaced by the ITU-T H.323 protocol (the protocol defined by ITU-T for voice and video transmissions over the Internet) or else by the Universal Mobile Telecommunications System (UMTS) protocol and Universal Plug-and-Play (UPnP) protocol with Java network technology of Sun Micro Systems (JINI) or by any other technology that envisages inter-operability of devices.

Implementation of the solution described herein was tested on a palmtop, where a UPnP VVoIP telephone and a UPnP VVoIP control point were installed. Linux personal computers (PCs) were used as Media Servers and television sets connected to PCs were used as Media Renderers. Furthermore, the architecture described enables setting-up of a VVoIP session by including each Media Server and each Media Renderer of a UPnP type identified in a home.

In order to reduce said complexity, it is envisaged to pass from a model based upon a single device to a multi-device model. The videophony applications can in fact be designed so as to be distributed on multiple devices, exploiting the capacities of each single physical device for the particular applications. For example, a videophony application can be managed by integrating a wireless videocamera, capable of supplying compressed audio/video applications on IP, with a device equipped with a decoder. In this way, it is not necessary to have a local videocamera and/or microphone and an audio/video encoder on the device.

The software for the management of a videophony session can be enriched with components and protocols for co-operating with distributed data sources. Typically, it is much simpler to add new software levels to a device than to add new hardware components.

This approach not only offers the opportunity of overcoming the limitations of the individual devices to obtain low-cost solutions, but may moreover be used for designing new and innovative applications.

For example, using distributed videophony applications, the user may be free to redirect (or re-address) the audio and video streams to other devices capable of reproducing them, as likewise he may be free to acquire audio/video data from any device capable of supplying them.

By way of example, we shall assume that there is available an IP set-top-box (IPSTB) device capable of managing videocalls, which is located in the living room of a home, and that the user wishes to make a call from the home office where a TV set and a wireless audio/video videocamera are installed. The user can decide to use these devices to make the call and can configure the IPSTB device set in the other room of the home remotely to organize correctly the call with the external videophone using a control point.

As an additional example, a user can moreover decide to acquire a video stream not directly from the videocamera, but from a series of photographs or else from a video, stored on a personal computer (PC) in another room.

To render this model efficient, the impact on the single device is rendered minimum, which means not having a software level markedly proprietory on the devices equipped with the new applications.

### BRIEF DESCRIPTION OF THE SEVERAL VIEWS OF THE DRAWINGS

The characteristics and advantages of the present invention will emerge clearly in the course of the ensuing detailed description, provided purely by way of non-limiting example, with reference to the attached plate of drawings, in which:

FIG. 1 shows an example of Universal Plug-and-Play architecture, according to one illustrated embodiment.

FIG. 2 shows an example of setting up and terminating a call between two users, according to one illustrated embodiment.

FIG. 3 is a typical home scenario in which an IPSTB device is present, according to one illustrated embodiment.

FIG. 4 shows an example of architecture according to one illustrated embodiment of the invention.

FIG. 5 shows an example of interaction between the devices present in the architecture of FIG. 4, according to one illustrated embodiment.

FIG. 6 shows a functional diagram of a device present in the architecture of FIG. 4, according to one illustrated embodiment.

FIG. 7 shows an example of interaction between external devices and devices present in the architecture of FIG. 4, according to one illustrated embodiment.

FIGS. 8, 9, and 10 show three examples of cases of use, according to some illustrated embodiments.

### DETAILED DESCRIPTION OF THE INVENTION

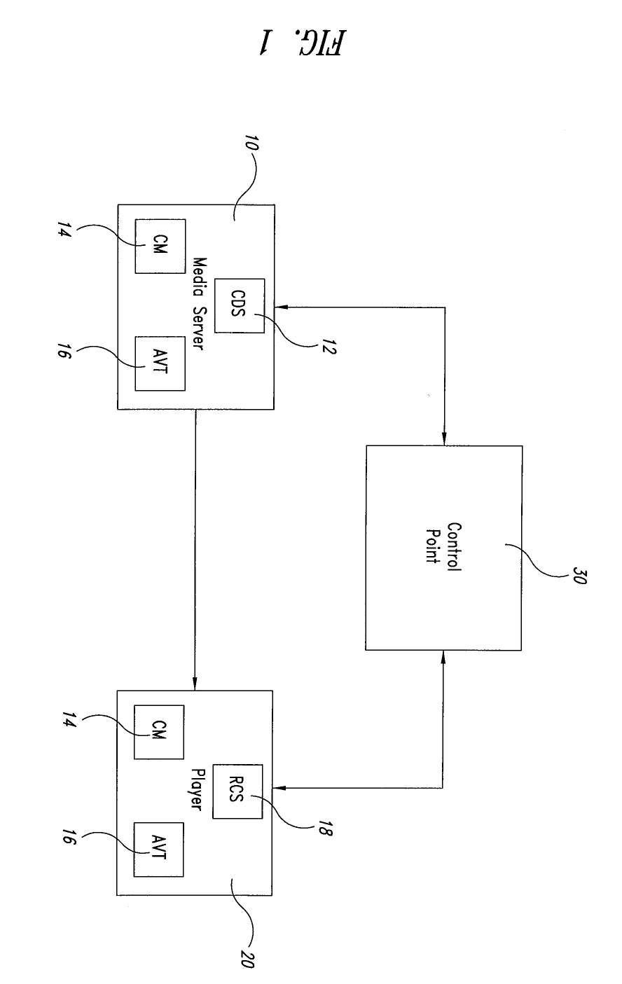

The audio-video architecture of FIG. 1 defines the three main logic entities that constitute an example of audio-video architecture: a communications server 10 (media source), a player 20 (media renderer or media player) and a control point 30 (media control point). Each of these entities can be considered as a single portion of equipment.

The Media Server 10 provides contents of entertainment and transmits these contents to other audio-video devices through a home network. It can be a CD or a DVD jukebox, a personal video recorder hard drive, a personal computer with an MP3 file, or a TV receiver.

The Media Player 20 receives contents external to the network and reproduces them on its local hardware. The player can be a stereo or multichannel system, a TV set, or even a set of amplified acoustic diffusers.

The control point 30 co-ordinates the operations of the Media Server 10 and of the Media Player 20 in order to fulfill and satisfy the requirements of the end user. Through the control point 30, a user selects a content that he wishes to hear or see. Via said control point 30, the user is moreover free to decide when to hear or see said content.

The aforesaid devices, namely, Media Control Point 30, Media Server 10, and Media Player 20, are based upon the Universal Plug-and-Play (UPnP) architecture and enable enhancement of the services for configuration and discovery of new devices.

The UPnP audio-video specifications can be viewed as an extension of the basic UPnP architecture. Within the audio-video specifications there exists a set of services that define the audio-video contents, which audio-video contents are available or supported, and optionally how to transfer and control the audio-video contents.

In the example considered here, there are four services offered by the server and renderer devices:
a Content Directory Service (CDS) 12 lists the contents available (video, music, photos, and so forth);
a Connection Manager (CM) service 14 determines in what way the contents can be transferred from the Media Server 10 to the Media Renderer 20;
an Audio Video Transport (AVT) service 16 controls the flow of contents (play, stop, pause, seek, etc.);
a Rendering Control Service (RCS) 18 controls in what way the content is reproduced (volume, silence, brightness, etc.) by the Media Renderer 20.

The SIP (RFC 3261) is a signaling protocol for setting up, managing, and terminating video and voice sessions through packet networks. The SIP sessions involve one or more participants and can use single or multiple communications.

Given that the SIP borrows capabilities from the Internet protocols, such as, for example, HTTP SMTP, it is highly flexible. The SIP can be configured to satisfy characteristics and services such as, for example, services for controlling calls, mobility, inter-operability with existing telephone systems, and the like.

A SIP network is made up of four types of SIP logic entities.

Each entity has a specific function and participates in the SIP communication as a client (entity that sends a request), as a server (entity that answers requests), or as both.

A physical device can have functions belonging to more than one SIP logic entity. For example, a network server working as a Server Proxy can also function as a Server Registrar at the same time.

Illustrated in what follows are the four types of SIP logic entities: the User Agent (UA), the SIP Proxy, the Redirect Server and the Registrar Server.

In the SIP, the User Agent (UA) is the terminal entity. The User Agent starts and terminates sessions, exchanging requests and replies. The User Agent can function as client (User Agent client) or a server (User Agent server); the two roles are dynamic, in the sense that in the course of a session a client can function as server, and vice versa. When it functions as client, it starts off the transaction, giving rise to requests. When it functions as server, it listens to the requests and satisfies them, if possible.

Some of the devices that can have a function of User Agent in a SIP network are workstations, IP telephones, telephone gateways, IPSTBs, call agents, automatic-reply services. The SIP Proxy is an intermediate entity that acts both as client and as server, with the purpose of making requests on behalf of other clients. The requests can be served either internally or by forwarding them to other servers. A SIP Proxy interprets and, if necessary, rewrites a request message before forwarding it.

The Redirect Server re-routes the SIP requests enabling the caller to contact the correct SIP entity. Unlike the Server Proxy, the Redirect Server does not forward the request to other servers.

The Registrar Server is a server that accepts registration requests with the purpose of updating a Data Base of the locations (Location Server) with the contact information of the users specified in the requests. There are two types of SIP messages:
requests sent by a client to a server; and
replies sent by a server to a client.

There exist different types of SIP request messages:
invite: this starts a call (or session) and changes the call parameters;
ack: this is an acknowledge or confirm message and is a final reply to the invite message;
bye: this terminates a call;
cancel: this cancels searches and notifies canceling with a “ringing”;
options: this queries on the capabilities of the other end;
register: this enables registration with the Location Server; and
info: this sends intermediate session information that does not modify the state of the session.

The reply messages contain numeric reply codes. The set of the SIP reply codes is partially based upon the HTTP reply codes.

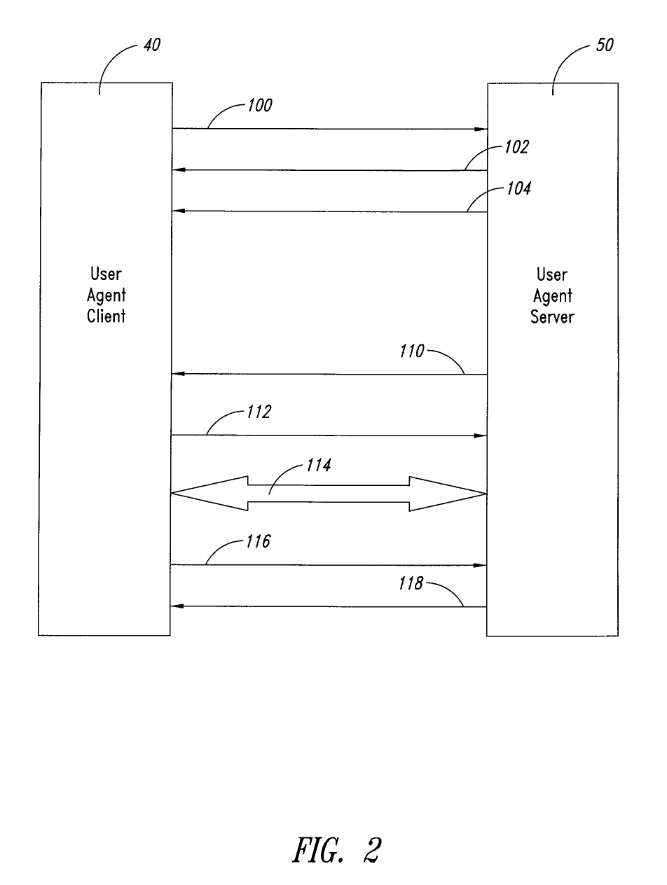

In what follows, illustrated with reference to FIG. 2 is an example of a scenario of interest.

Imagine that a User Agent client 40 is installed on an IPSTB and that the user Alice wishes to call the user Bob bob@lab.acme.com from her home.

The User Agent client 40 performing the call sends an invite message 100 to the Bob's SIP address: sip:bob@lab.acme.com. This message moreover contains an SDP (Session Description Protocol) packet, which describes the capability of communication of the caller terminal.

A User Agent server 50 receives the request and immediately answers with a reply message 102 “100/Trying”.

The User Agent server 50 starts to ring to inform Bob of the new call. Simultaneously, a message 104 of “180/Ringing” is sent to the User Agent client 40.

Bob receives the calls, and the User Agent server 50 sends a confirmation message 110 “200/OK” to the caller User Agent client 40. This message can moreover contain an SDP packet describing the capabilities of communication of Bob's terminal.

The caller User Agent client 40 sends a message 112 for a confirmation (ack) request to confirm that the reply message 110 “200/OK” has been received.

The call-termination session proceeds as follows: the caller decides to terminate the calls and hangs up. This generates a bye-request message 116 sent to Bob's User Agent server 50 at the SIP address sip:Bob@lab.acme.com. Bob's User Agent server 50 replies with a confirmation message 118 “200/OK” and notifies Bob that the conversation has terminated.

The Session Description Protocol (SDP) is the protocol used for describing announcements of multimedia sessions, invitations to multimedia sessions, and other forms of initialization of multimedia sessions.

A multimedia session is defined as a set of flows of communications that exist for a certain period of time.

The SDP packets typically include the information listed below.

a) Session information:
name of the session and target;
time for which the session is active;
information on the bandwidth to use for the session; and
contact information for the persons responsible for the session.

Since the resources necessary for participating in a session can be limited, the last two items of information may be added.

b) Communication information:
type of communication, for example video or audio;
transport protocol, such as, for example, RTP/UDP/IP, and H. 320;
communication format, for example, H 261 video, and MPEG video;
multicast addresses and transport ports for communications (IP multicast session); and
remote addresses for communications media and transport ports for contact addresses (IP unicast session).

The broadband IP networks, such as, for example, xDSL (x Digital Subscriber Line) network, provide the operators of telephone services with the opportunity to offer new services to their own customers.

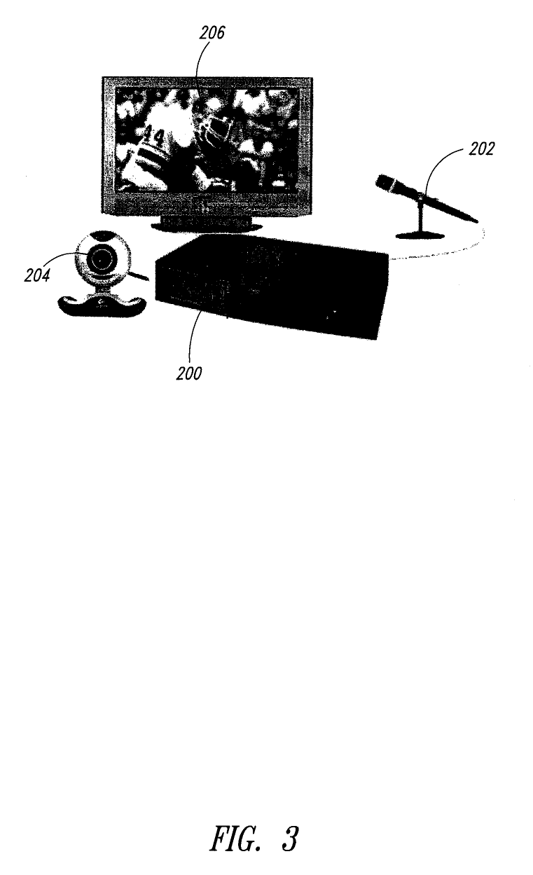

Illustrated in FIG. 3 is an IPSTB device 200 equipped with a microphone 202 and a videocamera 204 to offer a videophony application. Said architecture can offer to the user an XDSL access. The architecture further comprises a TV set 206.

In this case, the IPSTB device 200 is sold by the manufacturer with the hardware and software accompanying features (SIP/UDP/TCP/IP) that enable the videophony service on IP network.

The solution described avoids, for example, the need for the user to be very close to the IPSTB device in order to be able to make a call to another user (in fact, the microphone 202, the videocamera 204, and the TV set 206 are connected to the IPSTB device via a wired connection). The main advantage is represented by the possibility of using any UPnP device present in the home network (HN).

At the same time, the solution described does not require availability of additional hardware or software for handling the incoming and outgoing audio/video calls, thus increasing the performance of a UPnP application based upon a multi-device model that makes available video/voice applications on IP network (VVoIP).

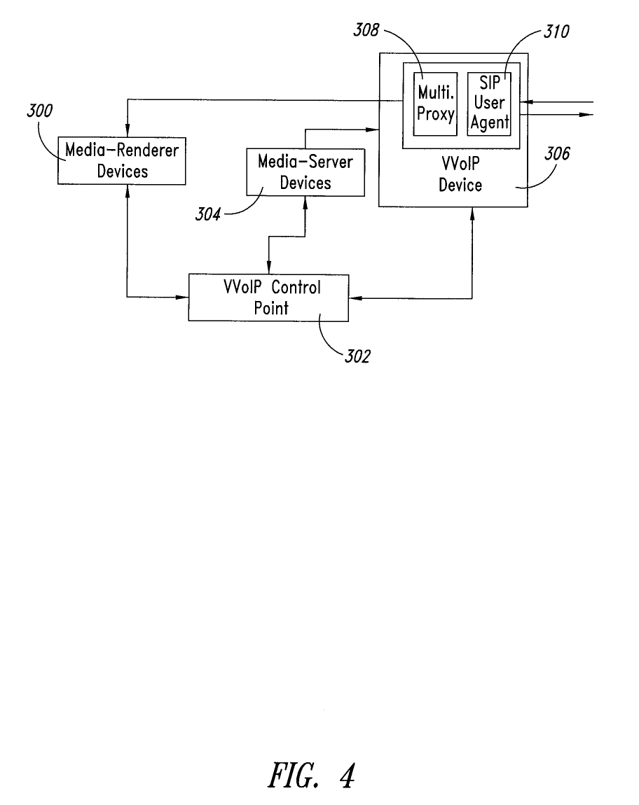

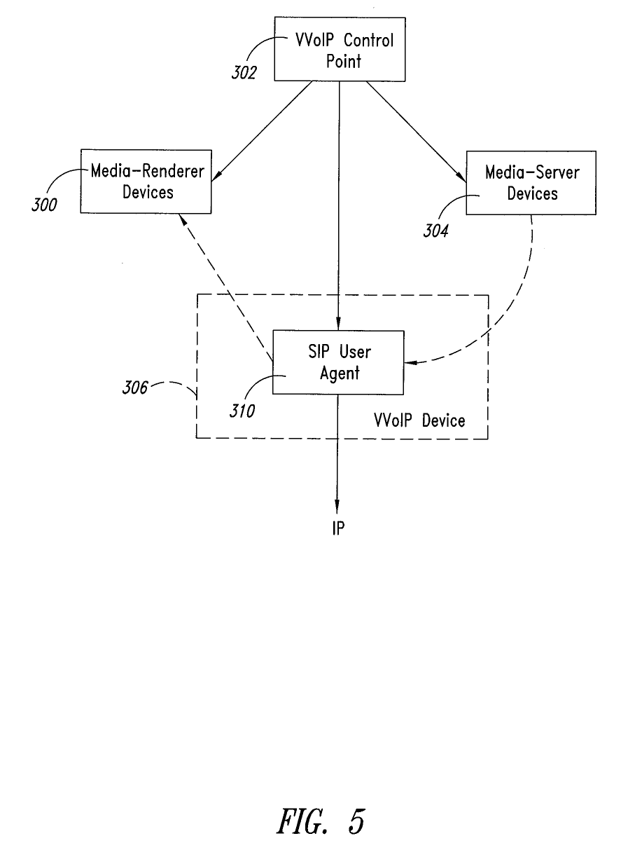

In the solution described herein, three new entities are proposed, which can be seen in FIGS. 4 and 5, namely, a UPnP VVoIP device 306, a UPnP VVoIP control point 302, and a Multimedia Proxy 308.

The UPnP VVoIP device 306 is a Universal Plug-and-Play device. Said device integrates a SIP User Agent 310 and implements all the protocols and services for inter-operation with other UPnP devices. The UPnP VVoIP device 306 can be installed on an IPSTB, a personal computer, a gateway, a PDA palmtop, a SmartPhone, etc.

The UPnP VVoIP device 306 can be identified and configured by a VVoIP control point 302 described in what follows.

The basic information for setting up a video and voice session on IP is:
the type of audio/video source; the source can be any Universal Plug-and-Play Media-Server device (for example, a wireless videocamera or a personal computer in which audio/video contents are stored) or a local videocamera directly accessible by the VVoIP application (local input);
the type of audio/video player; the player can be any Universal Plug-and-Play Media-Renderer device (TV set, personal computer, PDA palmtop), which can be used for reproducing a video and/or the voice of the user called or else a local player accessible by the VVoIP application;
the address of the user called.

The UPnP VVoIP control point 302 is a software application that the user employs to set up and manage his calls. The control point 302 enables discovery of all the existing Media-Server devices 304 and Media-Renderer devices 300 and moreover enables selection of the devices that will be involved in the call.

Furthermore, the VVoIP control point 302 is used for communicating to the UPnP VVoIP device 306 the address of the user called. The user can moreover change the Media-Server devices 304 and Media-Renderer devices 300 involved in the call dynamically. The VVoIP control point 302 can be implemented as part of any independent device, as a dedicated remote control, or as a part of the UPnP VVoIP device 306.

Some problems can arise in a typical home-network scenario. The home network is typically close to a NAT (Network Address Translator) server for translation of the addresses so that all the home devices have a private IP address, which, however, cannot access directly the external network (Internet) or be directly accessible thereby.

This means that the addresses that the SIP calls generate messages the contents of which cannot be dealt with in the public network. The Multimedia Proxy 308 is a software module that handles this situation, overcoming the need to render the private addresses known to the outside world. Traversal of the NAT device (not illustrated) is a problem that the SIP or other VVoIPs overcome.

Various solutions have been proposed to solve the above problem, such as, for example, the “Simple Traversal of UDP Through NAT”, STUN, described in “STUN—Simple Traversal of User Datagram Protocol (UDP) through Network Address Translator (NAT), RFC 3489”. In the traditional scenarios the association involves only a private IP address, because the SIP User Agent 310, the AV source 304, and the player device 300 are on one and the same physical device addressed by the same private IP address.

In the solution proposed here, the problem of NAT traversal is emphasized and rendered far more difficult by the fact that different physical devices, with their own private IP addresses, are involved in the call (and not only the device on which the SIP User Agent is installed). Consequently, it is difficult for a device to send traffic directly to the real destinee (for example, TV set or Bluetooth earphone).

Furthermore, the source and/or player devices can change dynamically over time, because the user can select new input/output devices. It is necessary to identify a route to determine rapidly the changes in the configuration and to forward the traffic to the correct destinations.

Finally, the audio/video synchronization is critical because audio and video can be reproduced on different devices. If the audio and video are out of synchronism, the quality of communication could prove seriously impaired.

In order to solve the above problems, the solution described here introduces a software module called Multimedia Proxy 308, to be integrated in the UPnP VVoIP device 306. The remote User Agent 335 will send all the traffic to the Multimedia Proxy 308, as established by the SDP during the initiation session. The Multimedia Proxy 308 will be responsible for forwarding all the traffic to the correct destinations within the UPnP private home network (HN).

An advantage of this solution is that it is completely transparent from the standpoint of the remote User Agent 335. According to the remote User Agent 335, the remote User Agent 335 is communicating with a traditional SIP User Agent. The remote User Agent 335 is unaware that the audio and video sources can be completely different devices having their own private IP addresses. This means that complete compatibility with a standard SIP User Agent is guaranteed.

With this solution, the problem of synchronization of audio and video is overcome because the two flows are synchronized in the Multimedia Proxy 308. The Multimedia Proxy 308 will use the transmitter RTCP (Real-Time Control Protocol) (RFC 3550) report for establishing a correspondence between predefined instants of the audio and video streams. In this way, the problem is attenuated because the loss of synchronization can only happen on the last connection (hop), which is located in the home network. Without a Proxy module, more complex mechanisms may be required to prevent loss of audio/video synchronization (such as, for example, running protocols of an NTP type on every device connected to the home network HN, and exchange of a large number of messages).

The interaction between the new entities and the devices of the UPnP AV architecture is illustrated in FIGS. 4 and 5.

From the standpoint of UpnP, the solution introduces only one new device, namely, the UPnP VVoIP device 306. Contained in the UPnP VVoIP device 306 is a Multimedia Proxy software module 308 and a SIP User Agent 310. The architecture of FIG. 4 moreover contains a UPnP VVoIP control point 302, designed to render the Universal Plug-and-Play devices inter-operable with one another. Normally, the control points are not standardized, and the manufacturers can build them as they prefer.

In the architecture described herein, a VVoIP multi-device application can be considered as an extension of the audio/video Universal Plug-and-Play architecture, where a new device is introduced, namely, the UPnP VVoIP device 306. Also present in FIG. 4 are, by way of example, a UPnP Media-Renderer device 300 and a UPnP Media-Server device 304.

A typical scenario of interaction between the entities of FIG. 4 is illustrated in FIG. 5. With reference only to the interactions between the UPnP VVoIP device 306, the UPnP Media-Renderer device 300 and the UPnP Media-Server device 304, the UPnP VVoIP device 306 can be considered as a device that can act both as Media Server and as Media Renderer. When the user wishes to redirect the video/audio data received from the caller to a Media-Renderer device 300, then the UPnP VVoIP device 306 acts as a Media-Server device for the Media-Renderer device selected. Instead, when the user wishes to transmit to the caller data acquired from a UPnP Media-Server device 304, the UPnP VVoIP device 306 acts as a Media-Renderer device for the Media-Server device selected.

According to what has been suggested in the UPnP AV architecture, even though the VVoIP control point 302 co-ordinates and synchronizes the behavior of all the devices, said devices interact with one another using a communication protocol that is not UPnP, i.e., an out-of-band protocol. The VVoIP control point 302 uses the UPnP protocol for initializing and configuring the devices so that the desired devices can be properly integrated in the VVoIP multi-device session.

However, since the content is transferred using an out-of-band transfer protocol, the VVoIP control point 302 is not directly involved in the current transfer of contents.

The VVoIP control point 302 configures the devices, sets up the calls, addresses the flow of contents, and finally leaves the stage. After the transfer is started, the control point 302 can be disconnected without interrupting the flow of contents.

The above behavior is illustrated in FIG. 5, where the solid arrows indicate the connections between the control point 302 and the other devices 304, 300 and 306, and the dashed arrows indicate the path of the flow of multimedia contents from/to the IP network. Once the UPnP VVoIP device 306, the Media Server 304 and the Media Renderer 300 are selected and configured, the call and the data transfer are obtained using an out-of-band communication. Hence, the UPnP VVoIP device 306 is responsible for the configuration of the call and for forwarding the data received from the Media Server 304 to the caller.

Furthermore, the UPnP VVoIP device 306 forwards the data received from the caller to the Media Renderer 300 selected. It is not compulsory to select and integrate a Media Server 304 and/or a Media Renderer 300; if one of these two devices is not selected, the UPnP VVoIP device 306 will use local devices, if available. The minimum requisite for starting a VVoIP session is to have one UPnP VVoIP device 306.

The multi-device architecture is based upon four independent logic devices: the VVoIP control point 302, the UPnP VVoIP device 306, the UPnP Media-Renderer device 300, and the UPnP Media-Server device 304.

These devices can be combined arbitrarily within a single physical device. For example, a VVoIP control point 302 and a UPnP VVoIP device 306 can be installed on an STB, on a PDA palmtop or on a smart phone that acts as remote controller. On the other hand, a Media Server 304 and a Media Renderer 300 of an UPnP type can be combined within a portable PC.

No further details regarding implementation of the Media Server 304 and Media-Renderer 300 devices of a UPnP type will be provided because these are UPnP audio/video devices of a standard type.

According to the standard on the UPnP AV architecture, the Media Server 304 contains, or has access to, a variety of entertainment contents that can be stored locally or on an external device, or else can be provided by a live source (for example, an Internet videocamera, which is accessible by means of the Media Server 304). The Media Server 304 is able to access its own contents and transmit them to another device by means of the home network HN using some types of transfer protocols. The contents presented by the Media Server 304 can include arbitrary types of contents, i.e., audio, video, and/or fixed images. The Media Server 304 can support one or more transfer protocols and one or more data formats for each object contained. The list of objects contained can be obtained through Browse/Search actions, and each object is listed with information regarding its format and the transfer protocol to be used. This information is used by the VVoIP control point 302 for controlling compatibility with the UPnP VVoIP device 306.

In the UPnP audio-video architecture, the Media Renderer 300 is prearranged to obtain and reproduce contents from a Media Server 304 through the HN. In the architecture, the Media Renderer 300 can obtain data also directly from the UPnP VVoIP device 306, which, from the standpoint of the Media Renderer 300, acts as a standard Media Server of a Universal Plug-and-Play type. Thus, no modification to the Media Renderer 300 is required.

The type of content that the Media Renderer 300 can receive depends upon the transfer protocals and upon the format of the data that it is able to support. Some Media Renderers can only support one type of contents, for example audio or fixed images, whereas other Media Renderers can support a wide variety of contents, including video, audio, and fixed images. A negotiation will be executed by the VVoIP control point 302.

The VVoIP control point 302 defines and manages a VVoIP multi-device session as though the session were directed by the user. In addition, the VVoIP control point 302 can provide a user interface (UI) for interacting with the user so as to control the operations of the UPnP VVoIP device 306 (for example, for selection of the desired content).

The module and user interface implemented by the VVoIP control point 302 depend upon the manufacturer, and in what follows an example of implementation of a module of the VVoIP control point for defining a VVoIP multi-device session will be described.

The main functions of the module described here are:

1—discovery of UPnP VVoIP devices 306: using a UPnP discover mechanism, all the UPnP VVoIP devices 306 contained in the home network are identified;

2—selection of a UPnP VVoIP device 306: this will be the device used for setting the VVoIP session; the capabilities of the device selected (for example, the availability of services, the format and protocols supported) are defined;

3—if the UPnP VVoIP device 306 selected supports the actions of the SIP SIPService::GetSinkProtocolInfo( ), all the UPnP Media Servers 304 are discovered;

4—location of the desired contents: if the previous step is true, by using the actions of the server ContentDirectory::Browse( ) or Search( ), a desired content is located; the information is returned by a Browse( )/Search( ) action and includes information on the transfer protocol and on the data format that the Media-Server device 304 supports for transferring the contents to/from the home network;

5—comparison/association of protocols/formats: the protocol/format information returned by the Content Directory for the desired content is associated to the protocol/format information returned by the operation executed by the UPnP VVoIP device 306 of SIPService::GetSinkProtocolInfo( ); the control point 302 selects a transfer protocol and a data format that are supported by both the Media Server 304 and the UPnP VVoIP device 306;

6—configuration of the application between the MediaServer 304 and the UPnP VVoIP device 306: the control point 302 calls the UPnP VVoIP device 306 AVT::SectransportURI, which will contact the Media Server 304 selected to define the connection for transfer of the content;

7—if the UpnP VVoIP device 306 supports the action of SIPService::GetSourceProtocolInfo( ), all the Media Renderers 300 of a UPnP type are discovered;

8—selection of a Media Renderer 300: the user can select the Media Renderer 300 where to forward the multimedia data sent by the caller;

9—comparison/association of protocols/formats: the protocols and formats returned by the Media Renderer 300 and by the UPnP VVoIP SIP device are associated. The control point selects a transfer protocol and a data format that are supported by both of the devices;

10—configuration of the connection between Media-Renderer device 300 and UPnP VVoIP device 306: the control point 302 calls the Media Renderer 300 AVT:SectransportURI, which will contact the UPnP VVoIP device 306 to define the connection for the transfer of the content;

11—start of a call transfer: the user will enter the User IDentifier (ID) to be called, and the control point will start the VVoIP session through the action of SIPService::Call( ) of the UPnP VVoIP device 306.

The minimum set of functions that the control point 302 implements is represented by the preceding points 1, 2 and 11; in this case, the VVoIP application will use local audio/video sources and receivers.

The functions 4 to 6 and 7 to 10 can be recalled by the user whenever he wishes to change the audio/video source or the audio/video receiver.

The UPnP VVoIP device 306 defines a “general purpose” device that can be used to identify the electronic user devices that provide SIP User Agent services and spread this information to other devices of a UPnP type in the home network. Said device makes available its own SIP User Agent 310 capabilities through the SIP services. Furthermore, it is able to receive and forward multimedia data to other Universal Plug-and-Play devices contained in the home. The latter capability will enable the user to define a VVoIP multi-device session that involves a UPnP Media Renderer and/or a UPnP Media Server. The actions necessary for defining this scenario are provided by the AV Transport and Media Server Source services.

The model of the UPnP VVoIP device 306 provides all the functions necessary for configuring a VVoIP multi-device session based upon the SIP.

A complete UPnP VVoIP device 306 has the following capabilities:
starting and controlling a VVoIP session using a SIP (the commands available include: call, hang-up, answer);
connecting a Media Renderer 300 to a VVoIP session;
connecting a Media Server 304 to a VVoIP session; and
listing the transfer protocols and the formats supported.

The SIP service is used for exploiting and managing a standard SIP session established by a SIP User Agent 310 contained in the UPnP VVoIP device 306.

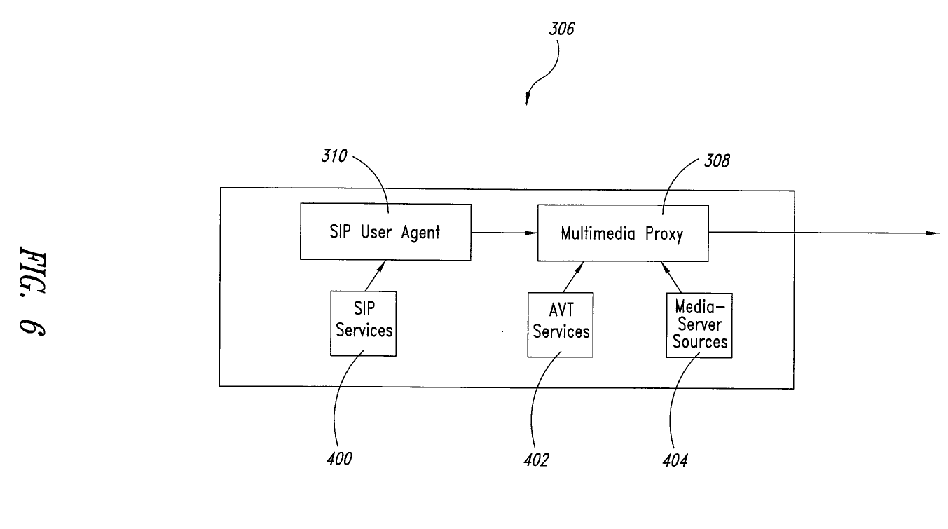

With reference to FIG. 6, the UPnP VVoIP device 306 comprises a SIP User Agent 310 and a SIP Multimedia Proxy 308. The SIP User Agent 310 offers the SIP services 400, whilst the SIP Multimedia Proxy 308 can optionally offer AV Transport services 402 and/or Media-Server Sources 404.

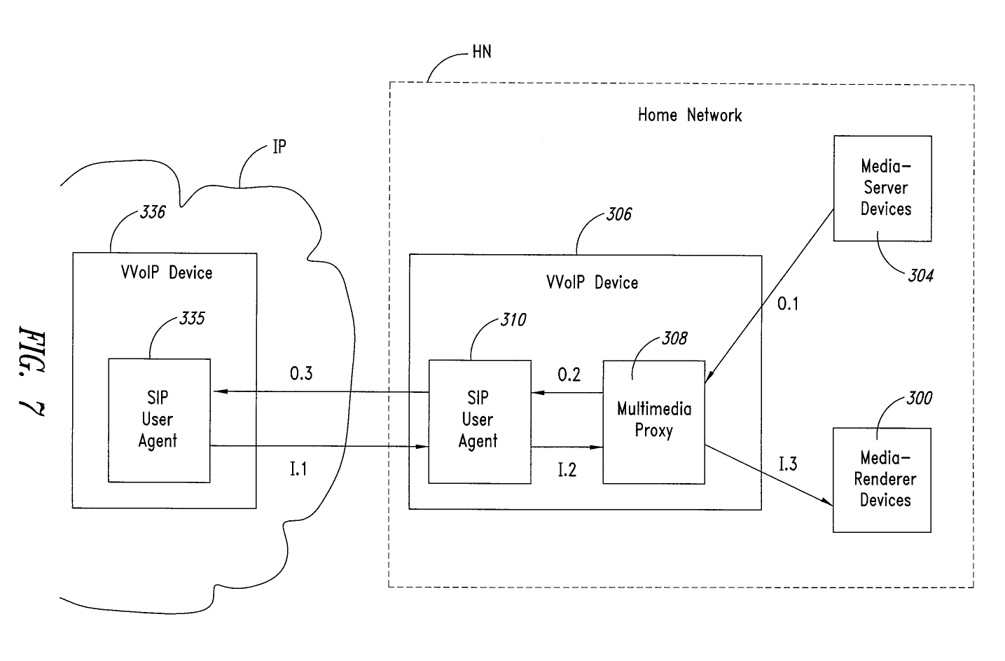

The main function of the SIP services 400 is the call. This action receives a valid SIP user address as input parameter. The action is invoked by the control point 302 for starting a call with a remote user (the called party). The SIP User Agent 310 integrated in the device 306 will use the information passed by the call action for starting the procedure of initiation of the videoconference session using the SIP. Negotiation of the communication between the local User Agent 310 and the remote User Agent 335 (FIG. 7) is obtained by means of the Session Description Protocol (SDP) included in the messages of a SIP type. The SDP provides details on the formats and codings supported. These details enable the two User Agents to agree upon a set of common formats and codings to be used for the calls. The formats and codings chosen are hence supported by the integrated SIP User Agent 310. Obviously, each Media Renderer 300 or MediaServer 304 that supports the same formats and the same codings contained in the SDP can be used in a transparent way during the calls. The SDP information includes IP addresses and ports so that the remote User Agent 335 can correctly establish the communication path. Thanks to the Multimedia Proxy 308, it is not necessary to inform the remote SIP user on the multiple IP addresses, one for each device present in the home network and involved in the video conference. Only the IP address and the ports of the Multimedia Proxy 308 are included in the SDP message, hence enabling dynamic change of the Media Server 304 and the Media Renderer 300 without the need to inform the interlocutor.

With reference to FIG. 7, a UpnP VVoIP device 306 in the home network HN dialogues with a UpnP VVoIP device 336 external to the home network HN and internal to the IP network. The exchange of messages takes place between the SIP User Agent 310 of the device 306 and a SIP User Agent 335 integrated in the UpnP VVoIP device 336. The SIP User Agent 310 of the device 306 communicates with the Media-Renderer device 300 and Media-Server device 304 present in the HN through the SIP Multimedia Proxy 308, which functions as intermediary.

The call action returns an error code (0 for success).

Furthermore, the SIP services include all the other main actions of the SIP User Agent 310 (such as, for example, hang-up and answer) used for managing a SIP session. The SIP service includes five actions:
call;
hang-up;
answer;
GetSinkProtocolInfo; and
GetSourceProtocolInfo.

The call action is invoked by the control point when a remote SIP user is to be called. The called party is specified input parameter.

The hang-up action is invoked when the control point wishes to terminate a current SIP session.

The answer action is invoked when the control point wishes to handle an incoming call. In this case, it is possible to accept or refuse an incoming call.

The GetSinkProtocolInfo action is optional; if present, it indicates the presence of the Multimedia-Proxy module 308 capable of accepting data from the Media Server 304. It returns the list of protocols and formats that can be used by the Media Server 304 to send data to the Multimedia Proxy 308.

The GetSourceProtocolInfo action is optional; if present, it indicates the presence of the Multimedia-Proxy module 308 capable of forwarding data to the Media Renderer 300. It restores the list of protocols and formats that can be used by the Media Renderer 300 for receiving data from the Multimedia Proxy 308.

The AV Transport service is a service already present in the specifications of the UPnP audio/video architecture. The main action of this service is SetAVTransporURI( ), which specifies the Uniform Resource Identifier (URI), which is an input parameter and is to be controlled by the specific AV Transport request.

The Media-Server Source service includes the “Prepare For Connection” action. This action is used to enable the device to prepare itself to connect up to the network with the intention of sending or receiving communication contents (for example a video stream). The parameters of this action identify the protocol, network, and format that must be used to transfer the content.

The Multimedia Proxy 308 is a software component, which interacts with the SIP User Agent 310 as illustrated in FIG. 7. When the VVoIP device 306 integrates a Universal Plug-and-Play Media Server 304 and/or a Universal Plug-and-Play Media Renderer 300, the multimedia data follow a three-jump path, where the second jump (O.2 and I.2) is an internal communication between two modules of one and the same device, whilst the other two jumps use a transfer protocol, not necessarily the same (for example the RTP can be used for transferring data from the VVoIP device 306 to the SIP User Agent 335 called, whilst UDP without RTP, RTP, or HTTP can be used to transfer data between the Media Server 304 and/or Media Renderer 300 and the Multimedia Proxy 308). The protocols for transfer within the UPnP home network are negotiated through the UPnP protocol, whilst the protocol for transfer between the called party and the caller is negotiated through the SIP (SDP).

As has been said previously, defining a VVoIP session involves selection of a UPnP VVoIP device 306, configuration, and start of a call; this scenario can be complicated by implementing a VVoIP multi-device scenario that involves a Media Server 304 and/or a Media Renderer 300 of a UPnP type.

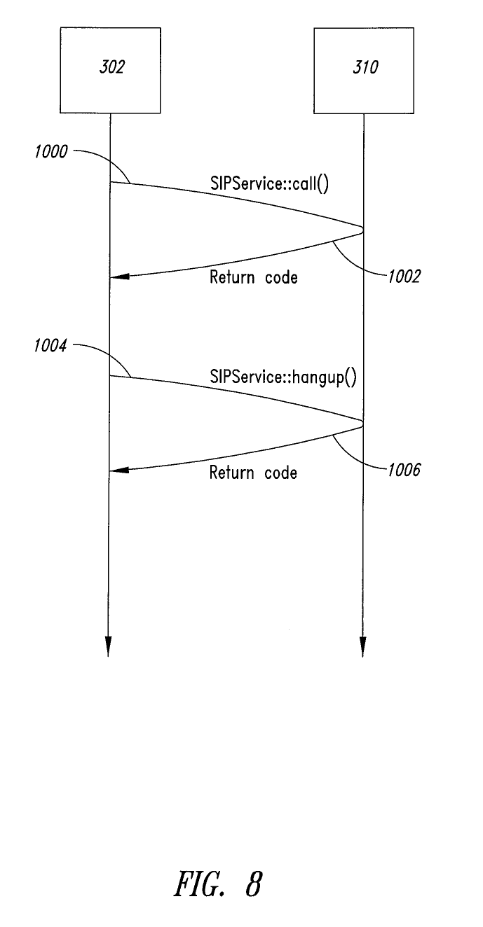

FIGS. 8, 9 and 10 illustrate three cases of use.

In the first case (FIG. 8) a call is defined without integrating any Media Server or Media Renderer.

The VVoIP control point 302, in a step 1000 invokes the action SIPService::call( ) on the SIP User Agent 310. The SIP User Agent 310 answers in a step 1002 with a Return-code message. The SIP User Agent 310 will use the standard SIP for managing the call with the user specified as parameter in the call action.

In a step 1004, the VVoIP control point 302 invokes the action SIPService::hangup( ) on the SIP User Agent 310 for terminating the call. In a step 1006, the SIP User Agent 310 answers with a Return-code message. The SIP User Agent 310 will use the standard SIP for terminating the call.

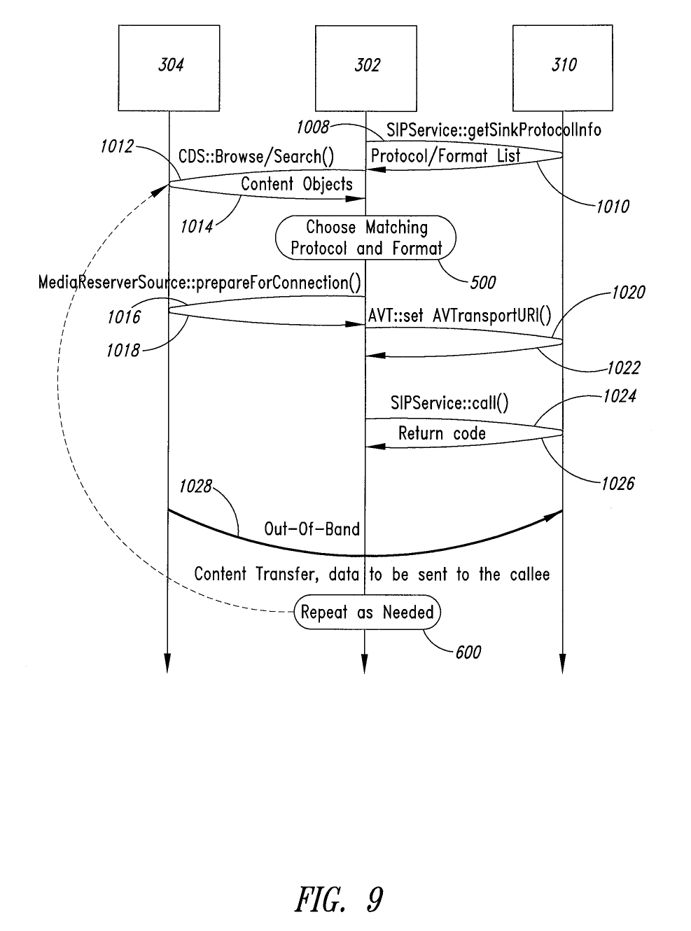

In the second case, illustrated in FIG. 9, a MediaServer 304 is used for acquiring audio/video data.

In a step 1008, the VVoIP control point 302 invokes the action SIPService::GetSinkProtocolInfo( ) on the SIP User Agent 310, which, in a step 1010, sends the list of protocols and formats Protocol/Format supported.

The VVoIP control point 302, in a step 1012, invokes the action CDS::Browse/Search( ) on the Media Server 304, which answers, in a step 1014, with a Content-Objects message.

In a step 500, the VVoIP control point 302 selects the protocol and format to use in the session, choosing a protocol and format that are common to the Media-Server device 304 and SIP-User-Agent device 310.

In a step 1016, the VVoIP control point 302 sends to the Media Server 304 a message of MediaReserverSource::PreapareForConnection( ), and the Media Server 304 answers in a step 1018. The VVoIP control point 302, in a step 1020, sends a message AVT::setAVTransportURI( ) to the SIP User Agent 310; the latter answers in a step 1022. The parameter passed with this message contains all the information for management of transfer of contents between the Media Server 304 and the SIP User Agent 310.

The VVoIP control point 302, in a step 1024, sends to the SIP User Agent 310 a message SIPService::call( ). The SIP User Agent 310, in a step 1026, answers with a Return-code message. The SIP User Agent 310 will use the standard SIP for managing the call with the user specified as parameter in the call action.

In a step 1028, there thus starts the transfer of the content from the Media Server 304 to the SIP User Agent 310. This is an out-of-band transmission. In a step 600 the VVoIP control point 302 repeats the previous operations, if necessary.

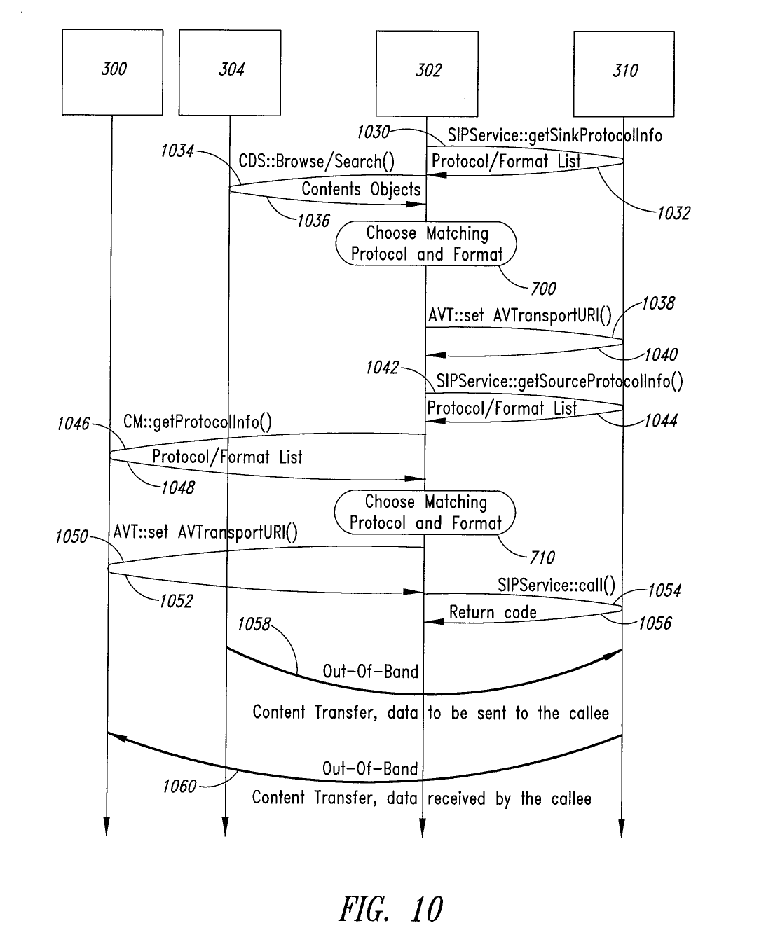

Finally, in the third case (FIG. 10) a Media Renderer 300 and a Media Server 304 are integrated in a VVoIP session.

In a step 1030, the VVoIP control point 302 invokes the action SIPService::GetSinkProtocolInfo( ) on the SIP User Agent 310, which, in a step 1032, sends the list of protocols and formats Protocol/Format supported.

The VVoIP control point 302, in a step 1034, invokes the action of CDS::Browse/Search( ) on the MediaServer 304, which answers, in a step 1036, with a Content-Objects message.

In a step 700, the VVoIP control point 302 selects the protocol and format to use in the session, choosing the protocol and format that are common to the Media-Server device 304 and SIP-User-Agent device 310.

The VVoIP control point 302, in a step 1038, invokes the action of AVT::setAVTransportURI( ) on the SIP User Agent 310, which answers in a step 1040. The parameter passed with this message contains all the information for management of transfer of contents between the MediaServer 304 and the SIP User Agent 310.

The VVoIP control point 302, in a step 1042, invokes the action SIPService::GetSourceProtocolInfo( ) on the SIP User Agent 310, which answers, in a step 1044, by sending the list of protocols and formats Protocol/Format supported.

The VVoIP control point 302, in a step 1046, invokes the action CM::GetProtocolInfo( ) on the Media Renderer 300, which, in a step 1048, sends the list of protocols and formats Protocol/Format supported.

In a step 710, the VVoIP control point 302 selects the protocol and format to use in the session, choosing protocol and format that are common to the Media-Renderer device 300 and SIP-User-Agent device 310.

In a step 1050, the VVoIP control point 302 sends a message AVT::SetAVTransportURI( ) to the Media Renderer 300, which answers in a step 1052.

The VVoIP control point 302, in a step 1054, sends a message SIPService::call( ) to the SIP User Agent 310. The SIP User Agent 310, in a step 1056, answers with a Return-code message. The SIP User Agent 310 will use the standard SIP for managing the call with the user specified as parameter in the call action.

In a step 1058, there thus starts transfer of the content from the Media Server 304 to the SIP User Agent 310. This is an out-of-band transmission.

In a step 1060, there moreover starts also a transfer from the SIP User Agent 310 to the MediaRenderer 300 caller, and also in this case it is of a an out-of-band transmission.

In the last two cases, the selection and configuration of the Media-Server device and Media-Renderer device is executed before setting-up of a call, but these operations can be carried out even when the call is already active. In this way, the user can vary the Media Server or the Media Renderer as he wishes.

Of course, without prejudice to the principle of the invention, the details of construction and the embodiments may vary widely with respect to what is described and illustrated herein purely by way of example, without thereby departing from the scope of the present invention, as defined in the ensuing claims.

1. A plug-and-play device for integration in a home network having at least one of an audio-video Media-Server device and an audio-video Media-Renderer device, the plug-and-play device comprising:
first means for selectively configuring parameters and for setting up audio-video calls for connection between said home network and a remote terminal; and
second means, coupled to the first means, for interfacing the plug-and-play device with the at least one of the audio-video Media-Server device and the audio-video Media-Renderer device.

2. The device according to claim 1 wherein the device employs Universal Plug-and-Playtechnology.

3. The device according to claim 1 wherein the first means is configured for using either a signaling protocol on an IP packet network, such as a Session Initiation Protocol and ITU-T H.323, or mobile communications systems, such as Universal Mobile Telecommunications Systems.

4. The device according to claim 1 wherein the second means is configured to perform at least one of:
redirecting audio-video streams in the context of a plurality of devices capable of reproducing said audio-video streams; and
acquiring selectively audio-video streams from a plurality of devices capable of supplying said audio-video streams.

5. The device according to claim 1, wherein the first means comprises a user agent for interfacing with a packet network or with a mobile communications system, such as UMTS.

6. The device according to claim 5 wherein said user agent supports a given set of formats and codings that can be used for setting up audio-video calls with said packet network or with said mobile communications system, such as UMTS.

7. The device according to claim 6 wherein said at least one of the audio-video Media-Server device and said audio-video Media-Renderer device supports formats and codings included in said given set of formats and codings supported by said user agent, so that said formats and codings can be used in a transparent way in said audio-video calls with said packet network.

8. The device according to claim 1, wherein the second means comprises a multimedia proxy server for interfacing with said at least one of the audio-video Media-Server device and said audio-video Media-Renderer device.

9. The device according to claim 8 wherein said multimedia proxy server comprises a communication module for communication between the remote terminal and the home network.

10. The device according to claim 9 wherein said communication module is configured for enabling dynamic change of the at least one of said audio-video Media-Server device and said audio-video Media-Renderer device.

11. The device according to claim 1 wherein the device is coupled to a control point, which is able to co-ordinate and synchronize behavior of the audio-video Media-Server device and the audio-video Media-Renderer device included in said home network.

12. The device according to claim 11 wherein said control point, after having set up the audio-video call for connection between said home network and said remote terminal, is disconnected without interrupting said connection.

13. A computer-program product comprises portions of code that, when loaded into a memory of at least one computer, implements using said at least one computer, a method comprising:
selectively configuring parameters and setting up audio-video calls between a plug-and-play device for a home network and a remote terminal; and
interfacing the plug-and-play device with at least one of an audio-video Media-Server device and an audio-video Media-Renderer device of the home network.

14. The computer-program product of claim 13 wherein the plug-and-play device is configured to use either a signaling protocol on an IP packet network, such as a Session Initiation Protocol and ITU-T H.323, or mobile communications systems, such as Universal Mobile Telecommunications Systems.

15. The computer-program product of claim 13 wherein the plug-and-play device comprises a user agent for interfacing with an IP packet network or with a mobile communications system, such as Universal Mobile Telecommunications System (UMTS).

16. The computer-program product of claim 13 wherein the plug-and-play device comprises a multimedia proxy server for interfacing with said audio-video Media-Server device and said audio-video Media-Renderer device.

17. A device operable to establish an audio-video connection between a home network and a remote terminal, the device comprising:
a user agent having a set of formats and codings, and operable to interface with the remote terminal; and
a multimedia proxy server operable to selectively interface destinations within the home network with the user agent.

18. The device of claim 17 wherein the remote terminal includes a packet network or a mobile communications system.

19. The device of claim 17 wherein the destinations within the home network include an audio-video Media-Server device operable to supply audio-video communication to the remote terminal via the user agent, and an audio-video Media-Renderer device operable to reproduce audio-video communication received from the remote terminal via the user agent.

20. The device of claim 19 wherein the multimedia proxy server is operable to redirect the audio-video communication received from the remote terminal via the user agent to the audio-video Media-Renderer device.

21. The device of claim 19 wherein the multimedia proxy server is operable to transmit the audio-video communication acquired from the audio-video Media-Server device to the remote terminal via the user agent.

22. The device of claim 19, further comprising a control point operable to synchronize operation of the audio-video Media-Server device and the audio-video Media-Renderer device.
